(19) United States
(12) Patent Application Publication
(10) Pub. No.: US 2017/0099977 A1
(43) Pub. Date: Apr. 13, 2017

(54) COOKING ASSEMBLY

(71) Applicant: Michelle Yusha Liu, Milpitas, CA (US)

(72) Inventor: Michelle Yusha Liu, Milpitas, CA (US)

(21) Appl. No.: 14/188,681

(22) Filed: Feb. 24, 2014

(51) Int. Cl. A47J 27/00; A47J 36/06; A47J 36/10; A47J 36/02

(52) U.S. Cl. CPC A47J 27/002; A47J 36/02; A47J 36/06; A47J 36/10

(57) ABSTRACT

An assembly comprises an outer housing. A cooking container is disposable within the outer housing. A thermal unit is disposed within the outer housing and is in engagement with the cooking container to transfer heat to the cooking container. A control unit is configured to be operable for controlling operations of the thermal unit. The control unit comprises at least a first mode for controlling temperatures of the thermal unit during incubation of a yogurt/dairy product in the cooking container, a second mode for controlling temperatures of the thermal unit during cooking of a food product in the cooking container, and a third mode for turning the thermal unit off.

### CROSS-REFERENCE TO RELATED APPLICATIONS

The present Utility patent application claims priority benefit of the U.S. provisional application for patent Ser. No. 61/769,164 entitled “COOKING ASSEMBLY”, filed on 25 Feb. 2013, under 35 U.S.C. 119(e). The contents of this related provisional application are incorporated herein by reference for all purposes to the extent that such subject matter is not inconsistent herewith or limiting hereof.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to cooking assemblies. More particularly, the invention relates to a cooking assembly for incubation of a yogurt/dairy product and for cooking of a food product.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art shows an electric clay and earthenware oven for general purpose heating, cooking, and baking having of a power switch, a thermostat, a timer, an indicator lamp, and a temperature indicator.

By way of educational background, another aspect of the prior art generally useful to be aware of shows an energy conserving automatic insulated thermal cooker having an inner pot having a cover, and an outer insulated container having an insulated cover.

By way of educational background, another aspect of the prior art generally useful to be aware of shows a programmable slow-cooker appliance that uses an application-specific integrated circuit digital controller, in which a user sets a time and temperature for cooking a food item.

By way of educational background, another aspect of the prior art generally useful to be aware of shows a slow cooker with two cooking controls for controlling a time and a temperature for cooking at a first desired temperature and maintaining a cooked item at a second desired temperature.

By way of educational background, another aspect of the prior art generally useful to be aware of shows a cheese making appliance with a cooking vessel, a curd stirring assembly in the cooking vessel, and a controller for the cooking vessel and stirring assembly.

By way of educational background, another aspect of the prior art generally useful to be aware of shows an electric cooking apparatus that can be used for many purposes and includes heating programs and a control device.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary cooking assembly in a closed position, in accordance with an embodiment of the present invention;

FIG. 2 illustrates a blow up view of an exemplary cooking assembly in an open position, in accordance with an embodiment of the present invention;

FIG. 3 illustrates a detailed perspective view of an exemplary heating coil joined with an exemplary cooking container, in accordance with an embodiment of the present invention;

FIG. 4 illustrates a blowup view of an exemplary cooking assembly, in accordance with an embodiment of the present invention;

FIG. 5 illustrates a sectioned view of an exemplary cooking assembly, in accordance with an embodiment of the present invention;

FIG. 6 illustrates an exemplary circuit diagram for an exemplary cooking assembly, in accordance with an embodiment of the present invention;

FIG. 7 illustrates an exemplary cooking assembly with an exemplary lid portion open to display an exemplary thermal plate, in accordance with an embodiment of the present invention; and

FIG. 8 illustrates an exemplary block diagram for a cooking system diagram, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

There are various types of cooking assemblies that may be provided by preferred embodiments of the present invention. In one embodiment, the cooking assembly may comprise a slow cooker or a rice cooker configured to incubate a dairy product. A temperature portion of the slow cooker or rice cooker may be manipulated to generate a temperature efficacious for cooking foods or incubating the dairy product. The cooking assembly may incubate the dairy product by performing the functions of containing, heating, and incubating starting ingredients for the desired dairy product. In one embodiment, the cooking assembly may be modified from a slow cooker or a rice cooker. Both the slow cooker and the rice cooker may be controlled by switch or switches or digital control/display panels. In this manner, manipulating the thermal energy transfer of a rice cooker may provide an assembly for cooking foods or incubating yogurt or other dairy products.

In one embodiment of the present invention, a single appliance may be used as a slow cooker or an incubator to enhance the production of yogurt or other dairy product. The appliance may include, without limitation, a slow cooker, a programmable slow cooker, a rice cooker, an induction cooker, a crockpot, a digital rice cooker, and a steamer. Those skilled in the art, in light of the present teachings, will recognize that processing dairy products requires an initial high temperature of about 176 degrees Fahrenheit to kill bacteria and denature milk proteins. After the milk is cooled and cultures are added, the temperature requirements may include a steady temperature about 100 to 118 degrees Fahrenheit for effective incubation of the milk to produce yogurt or other food products.

In some embodiments, the cooking assembly may include a cooking container for containing the dairy product. The cooking container may comprise a material suitable for incubating the dairy product, including, without limitation, clay, ceramic, earthenware, stoneware, porcelain, glass, enameled metal, coated or non-coated metal and stone. Those skilled in the art, in light of the present teachings, will recognize that a clay incubation cooking container may receive steady quantities of heat over a long period of time without damaging or affecting the quality of the dairy product. In some embodiments, the cooking container may include an inner lid for regulating access to the dairy product and protecting the contents of the cooking container. In one embodiment, the cooking container may include a clay cooking vessel. The clay cooking vessel may be used as an incubation container for producing a dairy product. The dairy product may include, without limitation, yogurt, yogurt cheese, cheese, cream cheese, sour cream, and cultured buttermilk. However, in other embodiments, the cooking apparatus may produce nondairy foods.

In one embodiment of the present invention, the cooking assembly may include an outer housing that contains the cooking container with a lid. The housing may provide a protective casing for the various components of the cooking assembly, including the cooking container with the dairy product. The housing may include a thermal portion for regulating the temperature. The thermal portion may be manipulated to provide a temperature range and temperature intensity efficacious for forming the dairy product. The thermal portion may include a thermal plate configured to engage the cooking container. At least one wire may join with the thermal plate to provide an electrical current. A power source may provide the necessary power to generate the thermal energy. Those skilled in the art, in light of the present teachings, will recognize that the plurality of wires and the power source may be manipulated to generate the appropriate temperature through various means, including, without limitation, wattage, current, wire diameter, wire placement, and thermal plate positioning on the cooking container. In some embodiments, a control portion may regulate a plurality of variables used to cook and incubate the dairy product. The plurality of variables may include, without limitation, power, temperature, time, pressure and humidity. In some embodiments, the housing may further include an outer lid configured to open and close in addition to the cooking container with a lid. In one alternative embodiment, the cooking assembly may include the outer lid, but not the inner lid. However, in other embodiments, the cooking assembly may include the inner lid, without utilizing the outer lid.

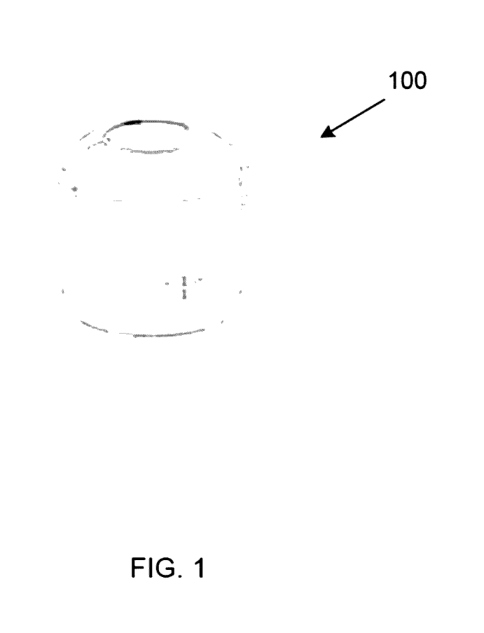

FIG. 1 illustrates a detailed perspective view of an exemplary cooking assembly in a closed position, in accordance with an embodiment of the present invention. In the present invention, the cooking assembly 100 may comprise a slow cooker or a rice cooker configured to incubate a dairy product. A temperature portion of the slow cooker or rice cooker may be manipulated to generate a temperature efficacious for cooking and incubating the dairy product. The cooking assembly may cook and incubate the dairy product by performing the functions of containing, heating, and incubating starting ingredients for the desired dairy product. In one embodiment of the present invention, a single appliance may be used as a slow cooker or an incubator to enhance the production of yogurt or other dairy product. The appliance may include, without limitation, a slow cooker, a programmable slow cooker, a rice cooker, an induction cooker, a crockpot, a digital rice cooker, pressure cooker and a steamer. Those skilled in the art, in light of the present teachings, will recognize that processing dairy products may require an initial high temperature of about 176 degrees Fahrenheit to kill bacteria and denature milk proteins. After the milk is cooled and cultures are added, the temperature requirements may include a steady temperature about 100 to 118 degrees Fahrenheit for effective incubation of the milk to produce yogurt or other food products.

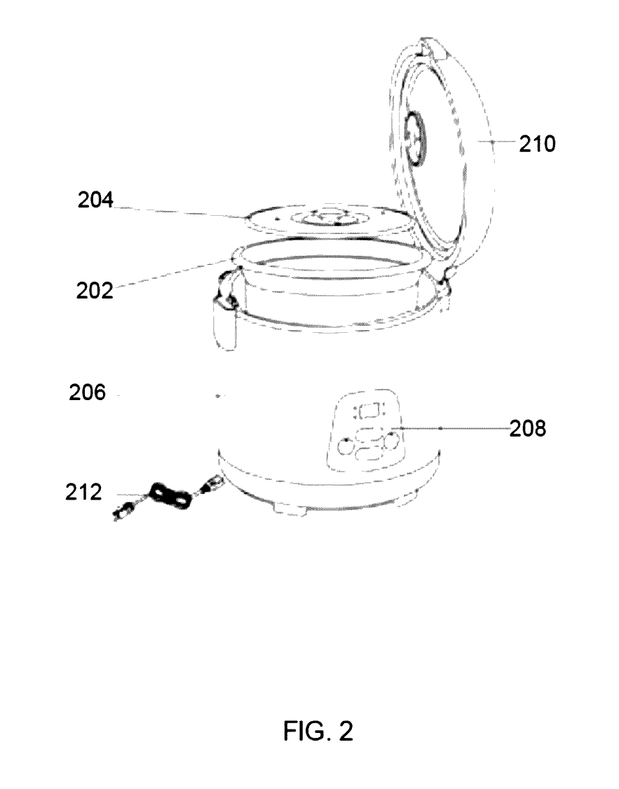

FIG. 2 illustrates a blow up view of an exemplary cooking assembly in an open position, in accordance with an embodiment of the present invention. In the present invention, the cooking assembly may include a cooking container 202 for containing the dairy product. The cooking container may comprise a material suitable for incubating the dairy product, including, without limitation, clay, ceramic, earthenware, stoneware, porcelain, glass, enameled metal, coated or uncoated metal, and stone, which could be glazed or non-glazed. Those skilled in the art, in light of the present teachings, will recognize that a clay or ceramic or stoneware or earthenware incubation cooking container may receive large quantities of heat to keep in a range of steady temperature over a long period of time without damaging or affecting the quality of the dairy product. In some embodiments, the cooking container may include an inner lid 204 for regulating access to the dairy product and protecting the contents of the cooking container. In one embodiment, the cooking container may include a clay or ceramic or stoneware or earthenware cooking vessel. The clay cooking vessel may be used as an incubation container for producing a dairy product. The dairy product may include, without limitation, yogurt, yogurt cheese, cheese, cream cheese, sour cream, and cultured buttermilk.

In one embodiment of the present invention, the cooking assembly may include an outer housing 206 that contains the cooking container. The housing may provide a protective casing for the various components of the cooking assembly, including the cooking container with the dairy product. The housing may include a thermal portion for regulating the temperature. The thermal portion may be manipulated to provide a temperature range and temperature intensity efficacious for forming the dairy product. For example, without limitation, the thermal portion may position beneath the cooking container to generate and transfer heat to and from the dairy product. The thermal portion may include a thermal plate configured to engage the cooking container. At least one wire may join with the thermal plate to provide an electrical current. A power source may provide the necessary power to generate the thermal energy. Those skilled in the art, in light of the present teachings, will recognize that the plurality of wires and the power source may be manipulated to generate the appropriate temperature through various means, including, without limitation, wattage, current, wire diameter, wire placement, and thermal plate positioning on the cooking container. In some embodiments, a control portion 208 may regulate a plurality of variables used to cook and incubate the dairy product. The plurality of variables may include, without limitation, power, temperature, time, pressure and humidity. In some embodiments, the housing may further include an outer lid 210 configured to open and close. In one alternative embodiment, the cooking assembly may include the outer lid, but not the inner lid. However, in other embodiments, the cooking assembly may include the inner lid, without utilizing the outer lid. The cooking assembly may be sized and dimensioned to cook and incubate a large quantity of yogurt, including, without limitation, 0.5 to 8 quarts. A power source 212 may transfer energy for heating and powering the cooking assembly. The power source may include, without limitation, an external power cord, a battery, and a solar panel.

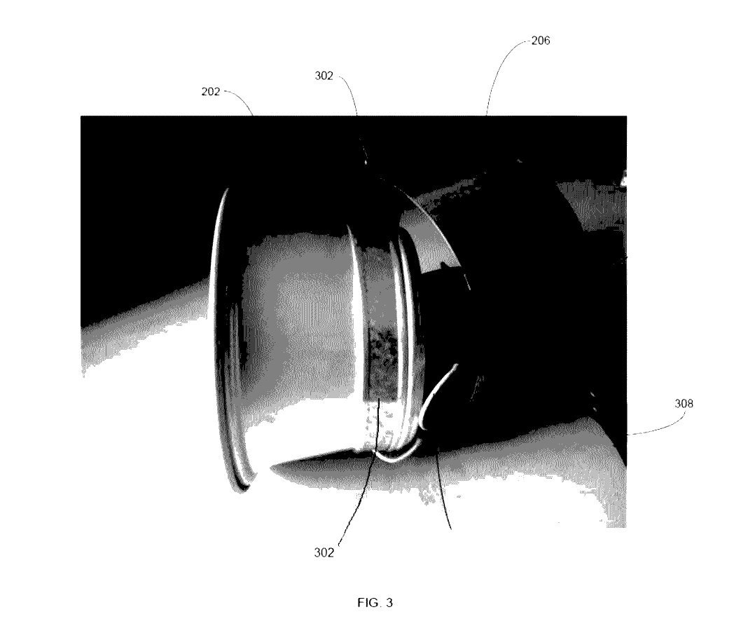

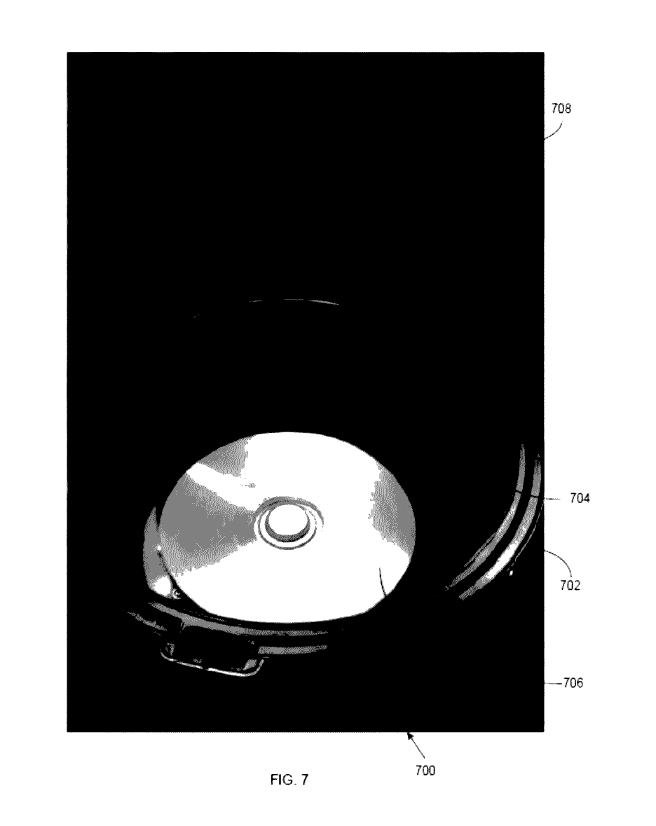

FIG. 3 illustrates a typical outer casing of a slow cooker that contains low-wattage heating coils. The component is responsible for cooking foods or incubating dairy products. These heating coils are completely encapsulated by the outer casing. in accordance with an embodiment of the present invention. In the present invention, the cooking assembly may coordinate the functions for producing a desired dairy product. Heating coils 302 may position adjacent or inside the housing to generate and transfer heat to the cooking container, and the dairy product. In some embodiments in FIG. 7, the thermal portion may generate sufficient thermal energy to cook foods or incubate the dairy product. A power source may provide the necessary power to generate the thermal energy. Those skilled in the art, in light of the present teachings, will recognize that the plurality of wires and the power source may be manipulated to generate the appropriate temperature through various means, including, without limitation, wattage, current, wire diameter, wire placement, and thermal plate positioning on the cooking container.

In one embodiment of the present invention, the thermal portion may include, without limitation, electrical wires, heat gauge, and heat pads. The control portion may regulate the amount and time period by which the heat generates. Those skilled in the art, in light of the teachings of the present invention, and depending upon the needs of the particular application, may configure said cooking assembly to include any suitable set of temperature settings and/or related sequencing behaviors. The temperature settings may include, without limitation, low, high, warm, auto, warm, and yogurt/dairy incubation, or any combination of “High”, “Low”, “Warm”, “Auto”, or “Off” with yogurt/dairy incubation.

Those skilled in the art, in light of the present teachings, will recognize that yogurt requires an initial high temperature about 176 degrees Fahrenheit to kill bacteria and denature milk proteins. After the milk is cooled and cultures are added, the temperature requirements may include a steady temperature about 100 to 118 degrees Fahrenheit for effective incubation of the milk to produce yogurt. The yogurt incubation setting of the temperature control portion may provide the 100 to 118 degree Fahrenheit temperature range necessary for incubation. The optimal temperature range for incubating yogurt may include, without limitation, between 105 to 110 degrees Fahrenheit. In some embodiments, the cooking assembly may provide a sufficiently consistent incubation temperature heat for effective incubation over a 5 to 24 hour time period. In some embodiments, the cooking assembly may include, without limitation, a slow cooker, a rice cooker, an induction cooker, a crockpot, pressure cooker and a steamer.

In one embodiment of the present invention, the cooking assembly may be sized and dimensioned to contain and incubate the dairy product. Suitable shapes may include, without limitation, an oval, a round, a square, and a rectangle. The shape of the cooking assembly may include sufficient surface area to engage a substantial amount of the dairy product. In this manner, thermal energy may transfer to and from the dairy product. Suitable materials for the cooking assembly may include, without limitation, clay, ceramic, earthenware, stoneware, porcelain, glass, enameled metal, metal and stone.

In one embodiment of the present invention, an electromechanical rice cooking apparatus may be modified to provide heat for incubating yogurt or other dairy product. The rice cooking apparatus may contain the cooking container. The rice cooker may include single or multi-function capabilities. In some embodiments, the rice cooker may include no adjustment capabilities. In some embodiments, the rice cooker may include, without limitation, electric rice cookers, large-scale rice cookers referred to as “rice boilers”, and fully programmable versions which cook many different type of grains and foods. Those skilled in the art, in light of the present teachings, will recognize that the digital slow cooker and the rice cooker may provide a sufficiently steady and gradual temperature increase whereby the dairy product may incubate.

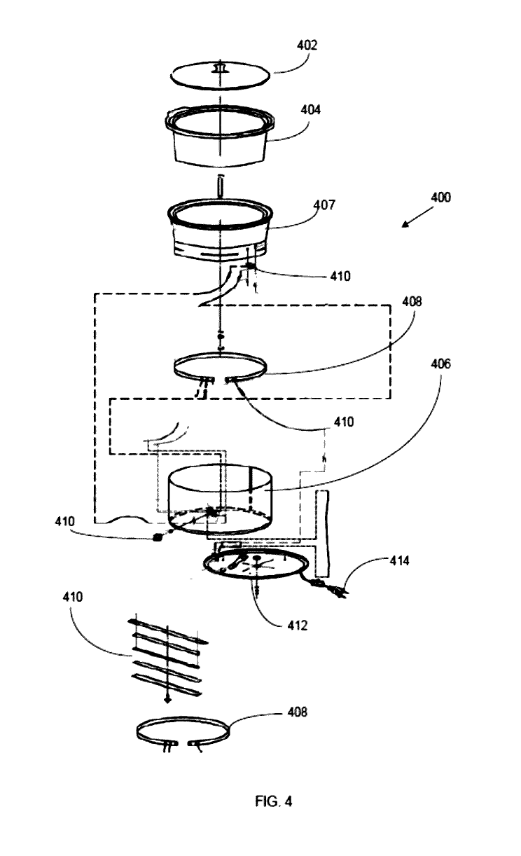

FIG. 4 illustrates a blowup view of an exemplary cooking assembly, in accordance with an embodiment of the present invention. In the present invention, a cooking assembly 400 may include multiple components that fit together for incubating a dairy product. The cooking assembly may include a lid portion 402 for regulating access to the dairy product. Suitable materials for the lid portion 402 may include, without limitation, clay, ceramic, earthenware, stoneware, porcelain, glass, enameled metal, fiberglass or tempered glass, aluminum, metal, and plastic. The cooking assembly may include a cooking container 404 for containing the dairy product. The cooking container may comprise a material suitable for incubating the dairy product, including, without limitation, clay pot, ceramic, earthenware, stoneware, porcelain, glass, enameled metal, metal, and stone. In some embodiments, the cooking assembly may include an outer housing 406 and 407 that contains the cooking container. Inside the housing there are heating coils wrapped around the inner wall of the housing providing a heat source. A heating coil 408 is mounted outside inner wall of the housing. At least one fastener 410 may secure the ring. In some embodiments, the thermal portion may generate sufficient thermal energy to incubate the dairy product. A power source 414 may transfer energy for heating and powering the cooking assembly. The power source may include, without limitation, an external power cord, or a battery.

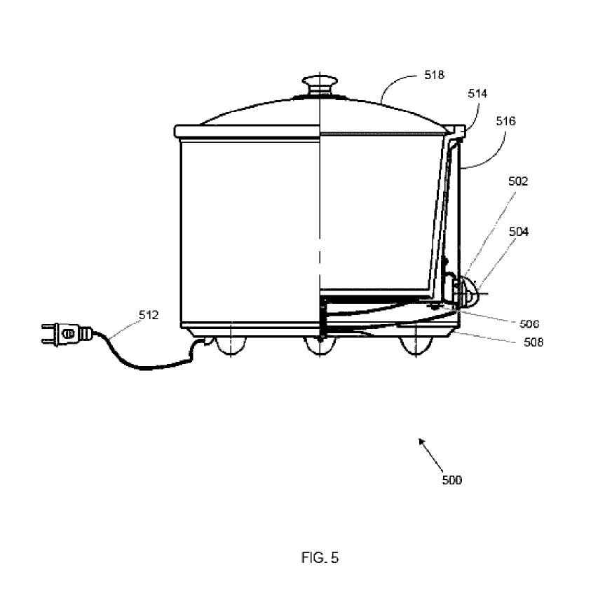

FIG. 5 illustrates a sectioned view of an exemplary cooking assembly, in accordance with an embodiment of the present invention. In the present invention, a cooking assembly 500 may allow for manipulation of a rice cooker or a slow cooker to incubate yogurt. The cooking assembly may include a switch 502 & 504 for selecting different temperature settings. A thermostat 506 may be operable to detect the temperature and trigger the switch. In some embodiments, a bottom plate 508 may provide a surface for supporting the circuitry. A power source 512 may transfer energy for heating and powering the cooking assembly. An outer housing 516 is used to protect electric wirings inside the housing walls. A lid portion 518 may position over an aperture in the outer housing.

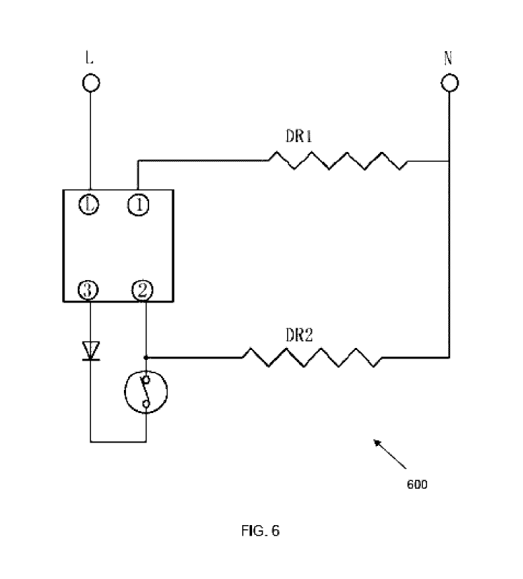

FIG. 6 illustrates an exemplary circuit diagram 600 for an exemplary cooking assembly, in accordance with an embodiment of the present invention. In the present embodiment, the cooking assembly may include a circuit to regulate the incubation of the dairy product. The circuit may include, without limitation, power source, relays, switches, diodes, thyristors, wires, voltage, current, resistors, and capacitors. In some embodiments, the cooking assembly may power Off when a current terminates at “L”. The cooking assembly may be on High when the current runs through “L-1-2”. The cooking assembly may be on Low when the current runs through “L-1”. The cooking assembly may be on Warm (Yogurt) when the current passes through “L-3”. Those skilled in the art, in light of the present teachings, will recognize that yogurt is formed while the cooking assembly is on Low.

FIG. 7 illustrates an exemplary cooking assembly with an exemplary lid portion open to display an exemplary thermal plate, in accordance with an embodiment of the present invention. In the present invention, a cooking assembly 700 may include an outer wall of the housing 702 for containing an inner wall of the housing 704. A container sits inside the housing. The container may be configured to cook food or incubating a dairy product. A thermal plate 706 may receive the thermal energy and transfer the thermal energy to the container. The thermal plate 706 may comprise a heating coil. An outer lid 708 may hingedly join with the outer housing to further regulate thermal energy to cook food or incubating the dairy product.

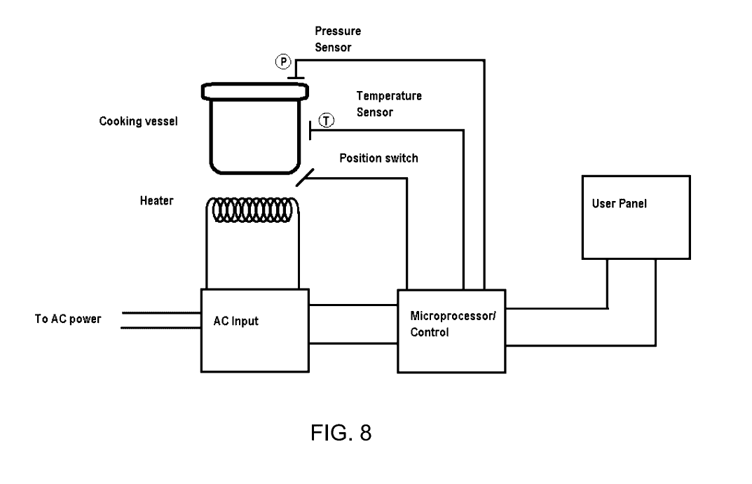

FIG. 8 illustrates an exemplary block diagram for a cooking system diagram, in accordance with an embodiment of the present invention.

The invention has been described above by way of illustration, and the specific embodiments disclosed are not intended to limit the invention to the particular forms disclosed.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of a cooking assembly according to the present invention will be apparent to those skilled in the art. Various aspects of the invention have been described above by way of illustration, and the specific embodiments disclosed are not intended to limit the invention to the particular forms disclosed. The particular implementation of the cooking assembly may vary depending upon the particular context or application. By way of example, and not limitation, the cooking assembly described in the foregoing were principally directed to incubation of a yogurt/dairy product and for cooking of a food product implementations; however, similar techniques may instead be applied to any food preparations requiring controlled temperatures and times, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An assembly comprising:
an outer housing;
a cooking container being disposable within said outer housing;
a thermal unit being disposed within said outer housing and in engagement with said cooking container to transfer heat to said cooking container; and
a control unit being configured to be operable for controlling operations of said thermal unit, said control unit comprising at least a first mode for controlling temperatures of said thermal unit during incubation of a yogurt/dairy product in said cooking container, a second mode for controlling temperatures of said thermal unit during cooking of a food product in said cooking container, and a third mode for turning said thermal unit off.

2. The assembly as recited in claim 1, further comprising a first lid being configured for regulating access to contents of said cooking container.

3. The assembly as recited in claim 2, in which said first lid is configured for engaging said cooking container.

4. The assembly as recited in claim 1, further comprising an outer lid being configured for engaging with said housing for covering contents of said housing.

5. The assembly as recited in claim 4, in which said outer lid is hingedly joined to said housing.

6. The assembly as recited in claim 1, in which said thermal unit comprises a heating coil being configured for engaging a bottom portion of said cooking container.

7. The assembly as recited in claim 6, in which said heating coil comprises a plate structure configured for contacting a bottom of said cooking container.

8. The assembly as recited in claim 1, further comprising a thermostat coupled to said control unit for detecting said temperatures.

9. The assembly as recited in claim 1, further comprising a plurality of switches being configured for selecting modes of said control unit.

10. The assembly as recited in claim 1, in which said cooking container comprises a clay pot.

11. The assembly as recited in claim 10, in which said clay pot is unglazed.

12. The assembly as recited in claim 1, in which said control unit further controls operating times for said modes.

13. The assembly as recited in claim 1, in which said housing further comprises an outer wall and an inner wall, said inner wall being separated from said outer wall.

14. The assembly as recited in claim 1, in which said housing and said cooking container are generally round in shape.

15. An assembly comprising:
means for housing;
means being disposable within said housing means for containing a food product;
means for transferring heat to said containing means; and
means for controlling operations of said transferring means, said controlling means comprising at least a first mode for controlling temperatures of said transferring means during incubation of a yogurt/dairy product in said containing means, a second mode for controlling temperatures of said transferring means during cooking of a food product in said containing means, and a third mode for turning said transferring means off.

16. The assembly as recited in claim 15, further comprising means for regulating access to contents of said containing means.

17. The assembly as recited in claim 15, further comprising means for covering contents of said housing means.

18. The assembly as recited in claim 15, further comprising means for detecting said temperatures.

19. The assembly as recited in claim 15, further comprising means for selecting modes of said controlling means.

20. The assembly as recited in claim 15, further comprising a pressure sensor or pressure switch operable for the controlling of pressure within said containing means.

21. An assembly comprising:
an outer housing comprising a generally round shape and having an outer wall and an inner wall, said inner wall being separated from said outer wall;
a cooking container being disposable within said outer housing, said cooking container comprising an unglazed clay pot;
a first lid being configured for regulating access to contents of said cooking container, said first lid being configured for engaging said cooking container;
a thermal unit being disposed within said outer housing, said thermal unit comprising a heating coil being configured for engaging a bottom portion of said cooking container to transfer heat to said cooking container; and
a control unit being configured to be operable for controlling operations of said thermal unit, said control unit comprising at least a first mode for controlling temperatures of said thermal unit during incubation of a yogurt/dairy product in said cooking container, a second mode for controlling temperatures of said thermal unit during cooking of a food product in said cooking container, and a third mode for turning said thermal unit off, said control unit further being configured for controlling operating times for said modes;
a thermostat being coupled to said control unit for detecting said temperatures;
a plurality of switches being configured for selecting modes of said control unit; and
an outer lid hingedly joined to said housing for covering contents of said housing.

22. The assembly as recited in claim 21 in which said cooking container comprises ceramic, earthenware, stoneware, porcelain, glass, enameled metal, coated or non-coated metal, or stone.

23. The assembly as recited in claim 21, further comprising a pressure sensor or pressure switch operabley-coupled to said control unit.
